(19) United States
(12) Patent Application Publication
(10) Pub. No.: US 2005/0237154 A1
(43) Pub. Date: Oct. 27, 2005

(54) Method and system for monitoring electronic sealing of containers

(75) Inventors: Eddy Kafry, Hod Hashron (IL); Zeev Inbar, Tel-Aviv (IL); Shemon Nahear, Jerusalem (IL)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Telematics Wireless Ltd., Holon (IL)

(21) Appl. No.: 10/961,165

(22) Filed: Oct. 8, 2004

(30) Foreign Application Priority Data
Apr. 4, 2004 (IL) 161303

(51) Int. Cl. H04Q 5/22

(52) U.S. Cl. 340/10.1; 340/572.1; 340/928

(57) ABSTRACT

The invention relates to a system for providing a combined monitoring over a toll-container sealing, weighing-container sealing, or border crossing-container sealing, which comprises: (a) a plurality of combined toll-seal, weighing-seal or border crossing-seal interrogators, which are mounted along highways, said interrogators transmitting a same interrogating signal in a same standardized communication protocol and at the same operating frequencies, by all interrogators; (b) a plurality of toll, weighing, or border crossing, whichever is the case, transponders which are installed in vehicles, and a plurality of container sealing transponders which are installed in containers, said sealing transponders by receiving interrogation signal transmit a sealing response signal which is distinct from corresponding toll, weighing, or border crossing response signals transmitted by toll, weighing, or border crossing transponders; (c) decoding means within each interrogator for receiving and decoding response signals, and for separating response signals coming from sealing transponders from those coming from toll, weighing, or border crossing transponders, whichever is the case; and (d) an analyzing unit within each interrogator for analyzing the status of each decoded response signal coming from a sealing transponder, and for transmitting a status of the sealing transponder, as included in the decoded signal, or the decoded signal itself to a control center.

### FIELD OF THE INVENTION

The present invention relates in general to means for electronic sealing of cargo containers. More particularly, the present invention relates to a method and system for monitoring electronic sealing of cargo containers, particularly during their transportation along highways.

### BACKGROUND OF THE INVENTION

Increasing losses due to thefts and increasing concerns for security have increased the need for tightening control over cargo containers. Initially, the principal purpose of cargo seals was to assure carriers, beneficial owners of cargo, and government officials that the integrity of a shipment is intact by acting as a ‘tell-tale’ for tampering. The terrorist events that occurred on Sep. 11, 2001 in the USA have increased the importance of cargo seals, and changed their focus. The focus of the seal has shifted from detection and/or protection against theft to overall security and integrity of the container and its stored cargo.

Port authorities, shipping, and ground transportation companies have, in the last decade, come to be extremely efficient organizations. Huge investments have been made in infrastructure throughout the entire container shipping cycle, end to end, in order to increase the handling rate of containers and improve the visibility of shipment status.

A conventional electronic seal transponder (hereinafter, “seal transponder”) for cargo containers, in its basic form, generally comprises a transponder which is associated with a sensor for detecting the opening of the container door, and memory means for registration of such an event. The transponder may be associated with additional sensors for the detection of container tampering. For example, the transponder may be associated with a GPS receiver for determining the global location of the container with motion detectors, light sensors, heat sensors, etc. If an event is sensed by a sensor, some data characterizing the event, such as the time, location, type of the event, etc. is registered within the memory of transponder. Compatible interrogators are provided by the prior art in order to communicate with the transponders, and obtain the events data stored, thereby enabling monitoring of the integrity of the containers.

The prior art have provided several systems for monitoring electronic seals of cargo containers. Some such systems were developed also with the capability of interrogating seal transponders of containers which are mounted on moving trucks. However, all the prior art systems have used proprietary communication protocols between the interrogators and the transponders, not enabling monitoring and control of all the containers, particularly while being on roads away from some central storage locations, such as ports.

Moreover, the costs of installing and maintaining a network of interrogators, which as said, in the prior art use proprietary protocols, are high. Each interrogator requires the supply of electricity, a housing for containing and protecting the interrogator, a fence and other means for protection against vandalism, a network for transferring the data, preferably in real time, personnel for maintenance and control, etc. Furthermore, as this monitoring issue involves criminal and security aspects, all said costs are mandatory, and they are also increased in comparison to conventional civilian systems. In view of the complexity and costs involved in installing a new, wide monitoring network for container sealing devices, the authorities have been forced until now to compromise by installing electronic seals interrogators of containers only at source and destination stations, generally ports. Only very few interrogators were installed at locations out of ports or central storing locations.

Now, when a need has arisen for tightening control over containers, also outside of the ports, and particularly on highways, railways and throughout the entire coarse of container transportation, this requires a huge investment in installing a wide network of new interrogators. The need for such installation not only involves the costs of the interrogators, it also involves all the associated costs as listed above. Moreover, even such a huge investment does not assure full control, in view of the varied proprietary systems that are currently used. Furthermore, the installation of such a wide network takes a very long time, as it also involves the need for purchasing real estate for each interrogator, solving local problems, communication regulations, etc. This is a problem which is not compatible with the urgent need for satisfying the security issues.

It is therefore an object of the present invention to enable the establishment of a wide network of electronic seal interrogators with substantially reduced costs.

It is another object of the invention to enable providing wide network of interrogators that can be operative within a very short time, almost immediately.

It is still another object of the invention to provide such a wide network with no need for solving problems concerning communication regulations, such as the assigning of special frequencies, etc.

It is still another object of the invention to provide an electronic seal interrogator which is able to communicate with electronic seal transponders, while maintaining high reliability and security.

Other objects and advantages of the invention will become apparent as the description proceeds.

### SUMMARY OF THE INVENTION

The present invention relates to a system for providing a combined monitoring over a toll-container sealing, weighing-container sealing, or border crossing-container sealing, which comprises: (a) a plurality of combined toll-seal, weighing-seal or border crossing-seal interrogators, which are mounted along highways, said interrogators all transmitting the same interrogating signal in the same standardized communication protocol and at the same operating frequencies; (b) a plurality of toll, weighing, or border crossing, whichever is the case, transponders which are installed in vehicles, and a plurality of container sealing transponders which are installed in containers, said sealing transponders by receiving interrogation signal transmit a sealing response signal which is distinct from corresponding toll, weighing, or border crossing response signals transmitted by toll, weighing, or border crossing transponders; (c) decoding means within each interrogator for receiving and decoding response signals, and for separating response signals coming from sealing transponders from those coming from toll, weighing, or border crossing transponders, whichever is the case; and (d) an analyzing unit within each interrogator for analyzing the status of each decoded response signal coming from a sealing transponder, and for transmitting a status of the sealing transponder, as included in the decoded signal, or the decoded signal itself to a control center.

Preferably, the interrogators and each of the electronic seal transponders communicate by using a standardized protocol, which is commonly used by weighing, border crossing, or toll systems.

Preferably, the interrogators and each of the electronic seal transponders communicate by using an ASTMv6 protocol.

The invention also relates to a method for performing combined toll-container sealing, weighing-container sealing, or border crossing-container sealing, comprising the steps of: (a) assigning within each container sealing transponder response signal a field which distinguishes the signal from a response signal of a toll transponder, weighing transponder or border crossing transponder, whichever is the case; (b) transmitting an interrogation signal from a combined toll-container sealing interrogator, weighing-container sealing interrogator, or border crossing-container sealing interrogator, whichever is the case; (c) upon receipt of a response signal at the interrogator, analyzing said field within the response in order to determine whether the response signal comes from a container sealing transponder; (d) if, based on said analysis, it has been found the response signal comes from a container sealing transponder, processing it as such; and (e) otherwise, processing the response signal as coming from a toll transponder, weighing transponder, or border crossing-transponder, whichever is the case.

### BRIEF DESCRIPTION OF THE DRAWINGS

FIG. 1 is a block diagram of a combined weighing-container sealing monitoring system, according to an embodiment of the invention; and

FIG. 2 illustrates an exemplary procedure which may be carried out by a combined weighing/seal, toll/seal or border/seal interrogator, according to a preferred embodiment of the invention.

### DETAILED DESCRIPTION OF PREFERRED EMBODIMENTS

It has surprisingly been found by the inventors that wide networks that, with relatively minor adaptations, can be used as interrogators for electronic seal devices, already exist in most countries.

For example, interrogators which are installed at border crossings or at the entrance to many highways can be adapted to also interrogate electronic seal devices. Alternatively, interrogators such as those used in truck weighing systems along highways can also be easily adapted to be used for this purpose.

In many developed countries, toll highways, and/or weighing systems comprise interrogators that use a standardized protocol for communicating with either a toll transponder or a weighing tag transponder respectively. All such systems are widely spread and can be easily adapted, according to the present invention, to also interrogate a compatible electronic seal transponder, while requiring only minor adaptations to them.

Weigh In Motion (WIM) interrogators are currently used in the U.S. trucking industry. Thousands of roadside weighing interrogators utilize the American Society for Testing and Materials version 6 (ASTMv6) protocol, that is supported by the Federal Highway Administration (FHWA) as a national Commercial Vehicle Operations (CVO) standard. The present weighing interrogator/transponder systems are adapted to operate at highway speeds, at long ranges (100 meters), very quickly ( 1/100 second), and with low latency ( 1/900 second). Moreover, many border crossings in the United States are also equipped with interrogators utilizing the same ASTMv6 protocol. The sealing transponders of the present invention preferably use an ASTMv6 protocol, and the interrogators are preferably those currently used in weighing systems and border crossings, with only minor adaptations. More particularly, according to the present invention, weighing, and toll, or border crossing interrogators are adapted to distinguish between signals coming from weighing, toll, or border crossing transponders, whichever is the case, and between signals coming from electronic seal transponders. The interrogators treat the two distinct signals separately, and differently.

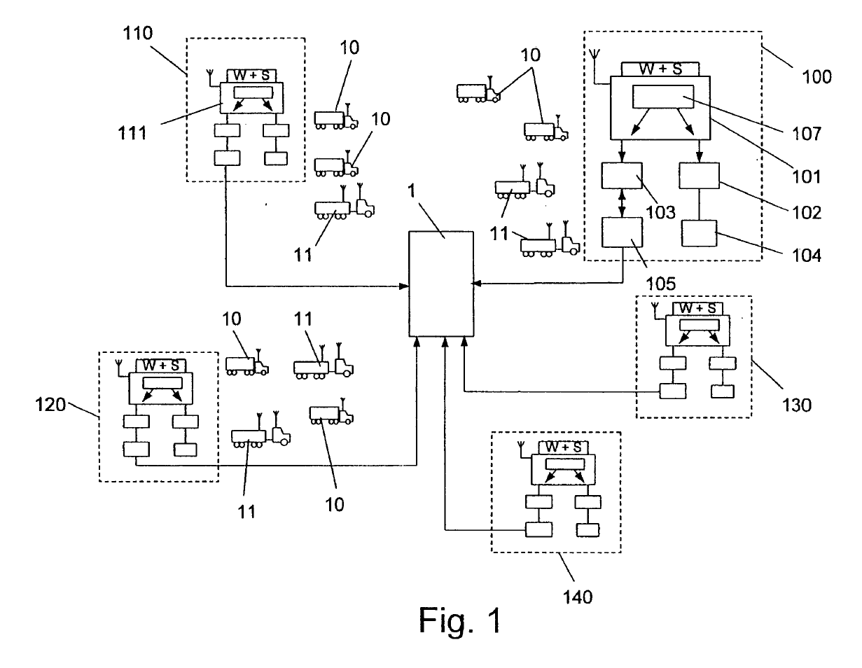

FIG. 1 illustrates a network for interrogating electronic seal devices, according to an embodiment of the present invention. The system according to this embodiment comprises a plurality of interrogating devices in weighing stations, such as those which are widely spread over the U.S. in the vicinity of highways or interrogating devices at border crossings. Such weighing stations and border crossings are already provided with interrogators that are capable of interrogating electronic transponders that are installed in trucks. In the U.S., weighing station interrogators and some border crossing interrogators are standardized to operate in a protocol known as ASTMv6. Use of this protocol in accordance with the invention is very advantageous as it is particularly adapted for use by electronic interrogators/transponders along highways and at border crossings, or more particularly, it is adapted for communication with transponders on vehicles moving at high speed, and with several such vehicles close one to another. As said, many weighing interrogators 100, 110, 120, . . . , (see FIG. 1) are already spread all over the country. Each interrogator transmits an interrogation signal, that if and when a truck 10, 11 having a transponder passes in the communication zone of the interrogator, and receives such an interrogation signal, it responds by transmitting a response signal. Generally, a response signal used by truck transponders indicates the ID of the truck.

According to an embodiment of the present invention, the same interrogation signal as presently used in weighing stations, border crossings, or highway toll, whichever is the case, is also used for interrogating electronic seal transponders, located on containers 11, which in themselves may, and generally are, also carried by trucks. Of course, according to the present invention, a truck may have a conventional WIM transponder, and may also carry one or more containers, each having its own electronic sealing transponder. However, as said, the response signal from an electronic seal transponder is distinguished from a response signal coming from a truck weighing transponder, in order to clearly indicate to the interrogator the type of responding transponder (seal transponder or weighing transponder, or border crossing transponder). The way of distinction in the response signal between the two types of transponders is conventional, i.e., by providing within the response signal a field with distinct codes for the two transponder types. When a response is received by an interrogator, it is first decoded and analyzed by decoder 107 in order to determine whether it comes from a weighing/truck transponder or from a container seal transponder. According to the decoding result, the response signal is transferred either to a weighing database 102 or to an electronic seal database 103 for further analyzing. If the response is transferred to a weighing database, it is analyzed by an analyzing unit 104 in the known, conventional manner, which will not be discussed herein in detail. If, however, the response comes from an electronic sealing device, the response is analyzed differently by analyzing unit 105, for determining the status of the sealing device, or more particularly, whether the response includes any indication of an event recorded by the device.

The analyzing unit 103 may then transfer any collected data relating to the status of each specific electronic seal device to a main control center 1 in a conventional manner.

The description of FIG. 1 has shown how a conventional weighing interrogation system can be used for the purpose of monitoring electronic sealing devices. In a similar manner, a border crossing or toll interrogation system can also be used for electronic seal monitoring. This latter option will not be discussed herein in detail, for the sake of brevity, and because it is very similar to the system of FIG. 1.

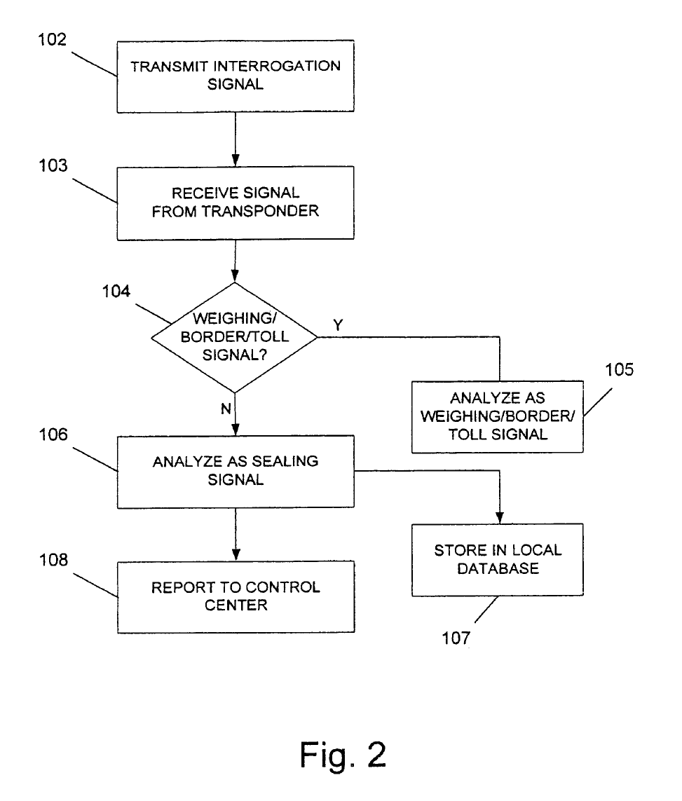

FIG. 2 illustrates a procedure which may be carried out by a combined weighing/seal interrogator, according to a preferred embodiment of the invention. In step 101, the procedure begins by transmitting an interrogation signal. In step 103, a signal is received at the interrogator from a transponder, the type of which is not known at this stage. In step 104, the type of the received signal is determined. If the signal is determined as coming from a weighing, border crossing or toll transponder, the procedure continues in step 105, in which the signal is analyzed and treated as a weighing/border/toll signal, in a manner which will not be elaborated. If, however, the signal is determined in step 104 as a sealing signal, the procedure continues in step 106, in which the signal is analyzed. According to the analysis, the signal data relating to the status of the transponder is either only saved in local database (107) and/or reported to a main control center (step 108).

The present invention involves at least the following major aspects:

a. Using existing infrastructure of toll, border crossings and/or truck weigh stations that already exist in vicinity of highways, in addition to their original purpose, also for the purpose of interrogating container electronic seals. More particularly, the present invention proposes using the same interrogators that are presently used for highway toll, border crossing monitoring, or control of weighing, also for the purpose of controlling container electronic seals;

b. Providing electronic seal transponders that operate in the same communication protocol and frequency band as used by toll highways interrogators, border crossing interrogators, or weighing stations interrogators;

c. Providing within the response of each electronic seal transponder a clear indication that the response comes from an electronic seal device, thereby distinguishing that response from a response coming from a toll or weighing transponder, whichever is the case;

d. Providing an appropriate decoding means within the interrogator for determining and separating responses coming from electronic sealing devices from those coming from toll, border crossing, or weighing transponders, whichever is the case, and also conveying the same to the corresponding channel (either toll/border crossing/weighing or sealing devices) for further analysis, handling and storage.

e. Providing or using any existing communication network, such as the Internet, for the transfer of data relating to electronic sealing interrogations or analysis results of the same to a main control center for further storage and analysis.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A system for providing a combined monitoring over a toll-container sealing, weighing-container sealing, or border crossing-container sealing, which comprises:
a plurality of combined toll-seal, weighing-seal or border crossing-seal interrogators, which are mounted along highways, said interrogators all transmitting a same interrogating signal in a same standardized communication protocol and at the same operating frequencies;
a plurality of toll, weighing, or border crossing, whichever is the case, transponders which are installed in vehicles, and a plurality of container sealing transponders which are installed in containers, said sealing transponders by receiving an interrogation signal transmit a sealing response signal which is distinct from corresponding toll, weighing, or border crossing response signals transmitted by toll, weighing, or border crossing transponders;
decoding means within each interrogator for receiving and decoding response signals, and for separating response signals coming from sealing transponders from those coming from toll, weighing, or border crossing transponders, whichever is the case; and
an analyzing unit within each interrogator for analyzing the status of each decoded response signal coming from a sealing transponder, and for transmitting a status of the sealing transponder, as included in the decoded signal, or the decoded signal itself to a control center;

2. System according to claim 1, wherein the interrogators and each of the electronic seal transponders communicate by using a standardized protocol, which is commonly used by weighing, border crossing, or toll systems.

3. System according to claim 2, wherein the interrogators and each of the electronic seal transponders communicate by using an ASTMv6 protocol.

4. Method for performing combined toll-container sealing, weighing-container sealing, or border crossing-container sealing, comprising the steps of:
assigning in each container sealing transponder response signal a field which distinguishes the signal from a response signal of a toll transponder, weighing transponder or border crossing transponder, whichever is the case;
transmitting an interrogation signal from a combined toll-container sealing interrogator, weighing-container sealing interrogator, or border crossing-container sealing interrogator, whichever is the case;
upon receipt of a response signal at the interrogator, analyzing said field in order to determine whether the response signal comes from a container sealing transponder;
if, based on said analysis, it has been found the response signal comes from a container sealing transponder, processing it as such;
otherwise, processing the response signal as coming from toll transponder, weighing transponder, or border crossing-transponder, whichever is the case.
